(19) United States
(12) Patent Application Publication
(10) Pub. No.: US 2010/0050421 A1
(43) Pub. Date: Mar. 4, 2010

(54) FUEL CELL MANUFACTURING METHOD, FUEL CELL SEPARATOR, AND TRANSPORTATION SYSTEM OF THE SAME

(75) Inventor: Yosuke Fukaya, Anjyo-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi-ken (JP)

(21) Appl. No.: 12/532,219

(22) PCT Filed: Mar. 4, 2008
(86) PCT No.: PCT/JP2008/054242

§ 371 Date: Sep. 21, 2009

(30) Foreign Application Priority Data
Mar. 22, 2007 (JP) 2007-075234

(51) Int. Cl. H01M 8/02; H01M 2/14

(52) U.S. Cl. 29/623.1; 429/34; 29/730

(57) ABSTRACT

A positioning mark (20) has a shape by which a position and a direction can be identified when moved together with a separator (10) along a plane. In other words, the positioning mark (20) is formed, for example, in a cross shape so that a position on the X-axis and a position on the Y-axis and the tilt in the θ direction of the positioning mark (20) can be identified. The positioning mark (20) is optically read by, for example, a sensor, and the positions on the x-axis and the Y-axis of the positioning mark (20) are calculated by, for example, image analysis processing. Based on the calculation result, positioning of the separator (10) is performed.

### TECHNICAL FIELD

The present invention relates to a fuel cell manufacturing method, and to a fuel cell separator and its transportation system, and particularly to a technology of positioning a fuel cell separator.

### BACKGROUND ART

Fuel cells in which fuel gases such as easily-oxidizable hydrogen are reacted with oxygen in the air and the obtained chemical energy is converted into electrical energy are well known. Generally, such fuel cells are formed using a plurality of battery cells which perform the above-mentioned chemical reaction. For example, a fuel cell employing flat battery cells is known. Here, the flat battery cells have a stacking structure in which separators made of electroconductive materials (for example, metals) are disposed on both sides of a plate-shaped membrane electrode assembly (MEA). A plurality of flat battery cells are stacked to form a cell stack to thereby form a fuel cell.

When the battery cell and the cell stack with the above-described structure are formed, it is desirable that the separators, the MEA, and the plurality of battery cells be accurately positioned and stacked with respect to one another. Therefore, some positioning technologies have been proposed.

For example, Japanese Patent Laid-Open Publication No. 2005-190946 (“Patent Document 1”) discloses an innovative technology of forming separators while allowing a runner to remain, and processing holes for transportation and positioning use on the runner, thereby enabling positioning of the separators with respect to one another or an MEA and the separators with one another and their transportation in a short period of time.

In addition, Japanese Patent Laid-Open Publication No. 2005-183182 (“Patent Document 2”) discloses a technology of providing, on an electrolyte membrane, a positioning mark detected by a visual sensor. Further, Japanese Patent Laid-Open Publication No. 2006-221897 (“Patent Document 3”) discloses a technology of providing through-holes in separators and stacking the plurality of separators so that penetration pins penetrate through the through-holes in the separators, thereby positioning the separators.

The technologies disclosed in Patent Document 1 and Patent Document 3 perform positioning using the holes provided on the runner or using the through-holes provided on the separator. The technology disclosed in Patent Document 3, in particular, is not capable of performing optical positioning. Further, the technology disclosed in Patent Document 2 provides a positioning mark on an electrolyte membrane.

### DISCLOSURE OF THE INVENTION

In light of the above-described background, the inventors of the present invention have researched and developed improved technology relating to manufacturing of fuel cells. The present invention was devised as a product of this research and development. The present invention provides a technology of optically positioning a fuel cell separator.

The present invention achieves this object by providing a method of manufacturing a fuel cell provided with a separator, including optically reading a positioning mark provided on a separator and positioning the separator based on the positioning mark, to thereby fix the separator.

The positioning according to the above embodiment may be used, for example, when stacking a separator and an MEA, when stacking separators with respect to one another, and when stacking battery cells formed by the separators with one another. When desired, it is possible to perform positioning more accurately and rapidly than when positioning is performed by, for example, fitting a penetration pin in a through-hole.

According to one aspect, the separator has a positioning mark outside a sealed region in which fluid flows. With this configuration, it is possible to reduce the influence of the positioning mark on electric power generation. It is also possible to prevent the positioning mark from being corroded by fluid.

In another aspect, the separator is formed in a plate shape having a direction of larger cross-sectional second order moment and a direction of smaller cross-sectional second order moment, and has the positioning mark in the center portion along the direction of the smaller cross-sectional second order moment. With this configuration, even when the separator warps along the direction of the smaller cross-sectional second order moment, the positioning mark is less likely to be influenced by deformation due to warp or the like because it is provided in the center portion.

In a preferred embodiment, the separator is formed in a plate shape and has the positioning mark on both sides.

In a preferred embodiment, the positioning mark has a shape by which a position and a direction of the positioning mark can be identified when the separator is moved along the plane. The positioning mark may be formed in the shape of a cross, a letter L or an arrow.

In a preferred embodiment, the positioning mark is marked on a separator together with identification information of the separator or a battery cell formed by the separator. The positioning mark is engraved using, for example, laser machining or pressing. The identification information and the positioning mark may be located close to each other to facilitate engraving.

In a preferred embodiment, the positioning mark is provided on the separator during a process of providing manifold holes in the separator, or during a process of providing a fluid flow path in the separator.

In a preferred embodiment, the positioning mark has features of being used for positioning the separator during a process of stacking the separator and an MEA to form a battery cell, and for positioning a plurality of battery cells during a process of stacking the plurality of battery cells Further, in order to achieve the above-mentioned object, the fuel cell separator according to a preferred embodiment of the present invention includes a positioning mark used for positioning the separator during assembly of a fuel cell. The positioning mark is provided on the separator in a fixed manner and is optically read during assembly of the fuel cell.

Still further, in order to achieve the above-mentioned object, a transportation system of a fuel cell separator according to a preferred embodiment of the present invention includes a suction hand having a suction surface corresponding to concave and convex portions on a surface of the fuel cell separator, and a sensor optically reading a positioning mark provided on the fuel cell separator. The position and the direction of the fuel cell separator is controlled by the suction hand that adsorbs the fuel cell separator based on the positioning mark read by the sensor, thereby positioning the fuel cell separator in place.

According to the present invention, a technology of optically positioning a fuel cell separator is provided. For example, according to a preferred embodiment of the present invention, it is possible, when necessary, to perform positioning more accurately and rapidly than when positioning is performed by, for example, fitting a penetration pin in a through-hole.

### BRIEF DESCRIPTION OF DRAWINGS

FIG. 1 shows a fuel cell separator according to the present invention;

FIG. 2 shows the surface of a suction hand according to the present invention;

FIG. 3 shows a stopper of a suction hand according to the present invention; and

FIG. 4 is a functional block diagram explaining a transportation system according to the present invention.

### BEST MODE FOR CARRYING OUT THE INVENTION

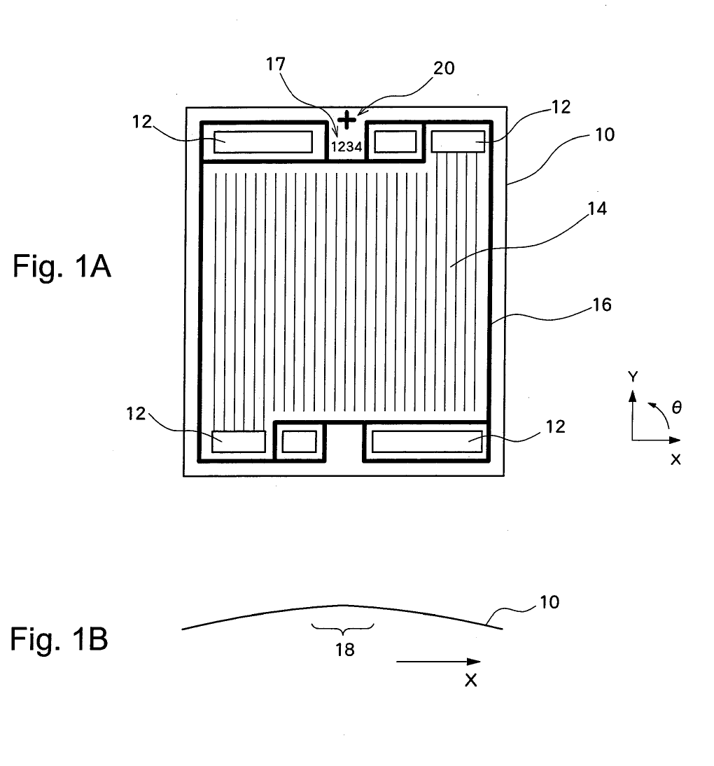

FIGS. 1 through 4 illustrate a preferred embodiment of the present invention. The preferred embodiment of the present invention will be described hereinafter referring to these figures.

FIG. 1 shows an example fuel cell separator according to the preferred embodiment of the present invention. FIG. 1 shows a separator 10 used in a fuel cell. The separator 10 is a plate-shaped member having front and rear surfaces both in an approximately rectangular shape, and is made of an electroconductive material such as an SUS material or carbon. Two separators 10 tightly hold an MEA in between, thereby forming a battery cell. A plurality of battery cells are then stacked, thereby forming a fuel cell.

FIG. 1(A) is a schematic view of the front surface of the separator 10. In a center region on the approximate rectangle surface, the separator 10 has a flow path 14 through which fluid flows. The flow path 14 is provided along the Y-axis direction. The region in which this flow path 14 is provided is surrounded by a sealing member 16 such as gasket. For example, when two separators 10 tightly hold an MEA functioning as a power generating layer to form a battery cell, the MEA is stacked so as to face the inner region (sealed region) surrounded by the sealing member 16. In the sealed region, a plurality of rectangular openings functioning as manifolds are provided. The positions and the shapes of the openings 12 shown in FIG. 1 are just examples.

In the present embodiment, a positioning mark 20 is provided on the surface of the separator 10. This positioning mark 20 is used to position the separators 10 and battery cells, when the separator is fixed in the manufacturing process of a fuel cell, including, for example, when the separator 10 and an MEA are stacked, when the separators 10 are stacked with respect to one another, or when the battery cells formed by the separators 10 are stacked with respect to one another.

The positioning mark 20 is marked on the separator 10 in a fixed manner. In addition, the positioning mark 20 has a shape by which a position and a direction can be identified when the positioning mark 20 is moved along the plane together with the separator 10. For example, the positioning mark 20 may be formed in a cross shape as shown in FIG. 1, and positions of the positioning mark 20 on the X-axis and on the Y-axis and the tilt in the θ direction can be identified when the positioning mark 20 is moved within the X-Y plane shown in FIG. 1. For example, the positioning mark 20 is optically read by a sensor (described later), and the positions on the X- and Y-axes and the tilt in the θ direction of the positioning mark are calculated by, for example, image analysis processing.

The positioning mark 20 is only required to have a shape by which the positions on the X- and Y-axes and the tilt in the θ directions can be identified. The positioning mark 20 therefore may be formed in the shape of, for example, the letter L, an arrow, a polygon, or another shape other than a cross shape. The positioning mark 20 desirably includes a line parallel to the X-axis and a line parallel to the Y-axis.

The positioning mark 20 is provided outside the sealed region (inner region surrounded by the sealing member 16) through which fluid flows. In this way, it is possible to reduce the influence of the positioning mark 20 on electric power generation and further prevent the positioning mark 20 from being corroded by fluid. Although in the configuration shown in FIG. 1 the positioning mark 20 is provided only on the upper side (the positive direction of the Y-axis), the positioning mark 20 may also be provided on the lower side or on both the upper and lower sides. Further, the positioning mark 20 may be formed on both front and back sides of the separator 10.

Also, the positioning mark 20 may also be marked on the separator 10 together with identification information 17 of the separator or the battery cell formed by the separators 10. In such a case, the identification information 17 and the positioning mark 20 may be engraved using, for example, laser machining or pressing. Furthermore, the identification information 17 and the positioning mark 20 may be close to each other so as to facilitate engraving. Also, the positioning mark 20 may be engraved using pressing or the like during a process of providing openings 12 on the separator 10 or in the process of providing a flow path 14 on the separator 10.

FIG. 1(B) is a schematic view of the bottom surface (side along the X-axis) of the separator 10. Because in this example the separator 10 is formed using pressing, cross-sectional second order moment in the X-axis direction is smaller compared to cross-sectional second order moment in the Y-axis direction. For this reason, the separator 10 deforms along the X-axis direction in the arch shape shown in FIG. 1(B). In order to minimize the influence of this deformation, the positioning mark 20 is provided in the center portion 18 which is relatively less likely to be influenced by the deformation.

The separator 10 is transported by a transportation system during assembly of the fuel cell. The transportation system is provided with a suction hand appropriate for the separator 10 in FIG. 1. The suction hand will be next described.

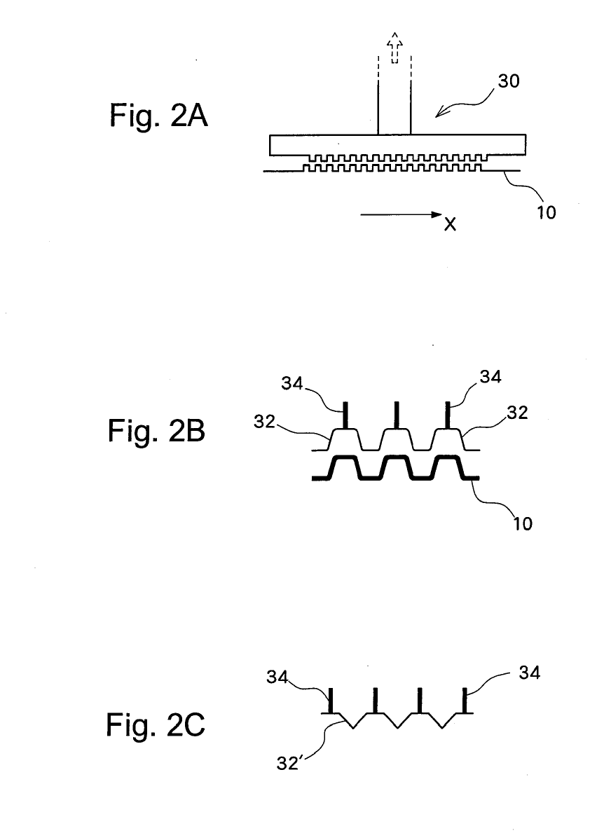

FIG. 2 illustrates a suction surface 32 of a suction hand 30 according to the present embodiment. The suction hand 30 is provided with the suction surface 32 to be stacked on the surface of the separator 10. FIG. 2(A) is a schematic view of the suction hand 30 and the separator 10 from the side of the bottom surface of the separator 10. The suction hand 30 suctions air, and with this suction force, adsorbs the separator 10. In the state in which the separator is adsorbed, the warp of the separator 10 is corrected to be straight along the suction surface of the suction hand 30.

FIG. 2(B) is an enlarged view showing the suction surface 32 of the suction hand 30. The surface of the separator 10 is formed with concave and convex portions along the X-axis direction in the region where the flow path (flow path 14 in FIG. 1) is provided. The suction surface 32 of the suction hand 30 is formed with concave and convex portions along the X-axis in accordance with the surface shape of the separator 10. The suction surface 32 is provided with suction holes 34. The air is suctioned through the suction holes 34, thereby adsorbing the separator 10 to the suction surface 32.

Because, as shown in FIG. 2(B), the suction surface 32 is formed with concave and convex portions in the X-axis direction, shifting of the adsorbed separator 10 in the X-axis direction is prevented. Also, because the surfaces of the suction surface 32 and the separator 10 have shapes which fit each other, the degree of fit between the suction surface 32 and the separator 10 is increased. It is also possible to reduce the amount of suction force required, compared to when the degree of fitting is low. The shapes of the concave and convex portions of the suction surface 32 may be different from those of the separator 10. For example, the suction surface 32 may have triangle convex portion, as in the suction surface 32′ shown in FIG. 2(C).

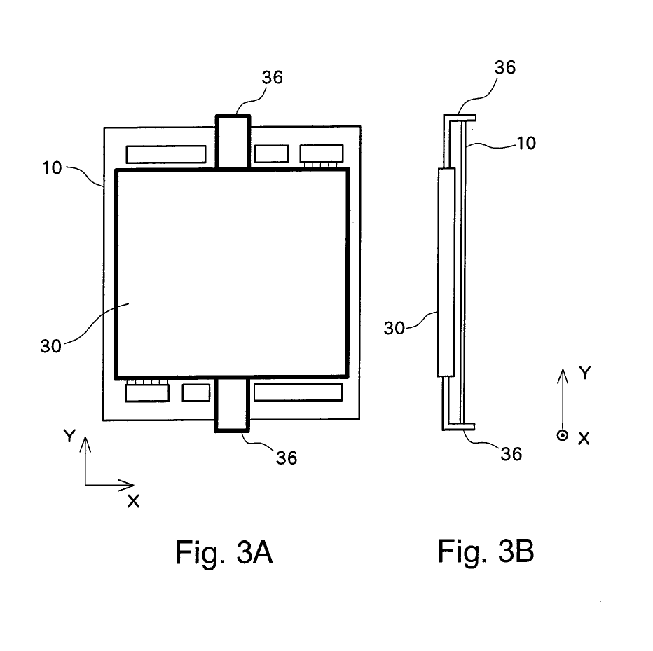

FIG. 3 describes stoppers 36 of the suction hand 30 according to the present invention. FIG. 3(A) is a schematic view of the suction hand 30 and the separator 10 when viewed over the surface of the separator 10. In addition, FIG. 3(B) is a schematic view of the suction hand 30 and the separator 10 when viewed from the side of the right side surface of the separator 10.

The suction hand 30 is provided with the stoppers 36 at both ends in the Y-axis direction. As explained using FIG. 2, the suction surface of the suction hand 30 has the shape corresponding to the surface of the separator 10, so that the absorbed separator is prevented from being shifted in the X-axis direction.

Meanwhile, the stoppers 36 shown in FIG. 3 prevent the adsorbed separator 10 from being shifted in the Y-axis direction. In other words, the tips of the stoppers 36 catch on the side surface of the separator 10, thereby preventing the separator 10 from being shifted in the Y-axis direction.

Because the separator 10 deforms in an arch shape in the X-axis direction, it is desirable to provide the stopper 36 in the center portion in the X-axis direction, which is relatively less likely to be influenced by the deformation. In addition, as shown in FIG. 3(A), when the stopper 36 is disposed above the positioning mark of the separator 10 (positioning mark 20 in FIG. 1), a sensor for optically reading the positioning mark is provided, for example, on the surface of the stopper 36 facing the separator 10.

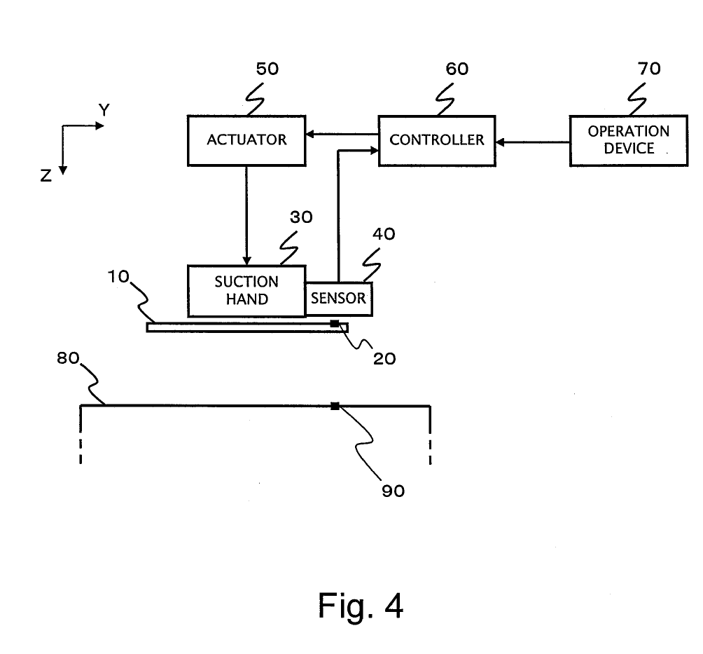

FIG. 4 is a functional block diagram explaining the transportation system according to the present invention. The transportation system shown in FIG. 4 is a system transporting the separator 10 to a work area 80 during assembly of a fuel cell.

The suction hand 30 adsorbs the separator 10 as described using FIGS. 2 and 3. This suction hand 30 is moved by an actuator 50. In other words, the suction hand 30 is moved in the X-axis direction, the Y-axis direction and the θ direction, and, in addition, in the Z-axis direction shown in FIG. 3.

Further, the suction hand 30 is provided with the sensor 40 optically reading the positioning mark 20 provided on the separator 10. In this example, the sensor 40 is an imaging device such as a CCD, but it is not limited to this. The controller 60 controls the actuator 50 based on the positioning mark 20 read by this sensor 40, thereby performing positioning of the separator 10 adsorbed to the adsorbing hand 30. Performing of positioning will be next described.

When the suction hand 30 adsorbs the separator 10, the sensor 40 reads the positioning mark 20. The positioning mark 20 is formed in, for example, the cross shape as shown in FIG. 1. The controller 60 detects the center location of the cross-shape positioning mark 20 (crossing point of the cross), and, based on the center location, identifies a position of the positioning mark 20 in the X-Y plane (see FIG. 1)—that is, the coordinate on the X-axis and the coordinate on the Y-axis. The controller 60 further detects the tilt of the line section of the cross shape positioning mark 20 along the Y-axis, and identifies the tilt of the positioning mark 20 (the tilt in the θ direction in FIG. 1) based on the tilt.

When the position and the tilt of the positioning mark 20 are identified, the controller 60 controls the actuator 50 based on the position and the tilt and actuates the suction hand 30. The actuator 50 appropriately moves the suction hand 30 in the X-direction, the Y-direction and the θ direction shown in FIG. 1, and further in the Z axis direction shown in FIG. 4. Then, the separator adsorbed to the suction hand 30 is transported to the work area 80.

In the work area 80, a reference mark 90 is provided. The reference mark 90 is formed, for example, in a cross shape like the positioning mark 20. The controller 60 controls the actuator 50 to actuate the suction hand 30, and controls the position and the direction of the separator 10 to place the separator 10 in the work area 80 so that, for example, the reference mark 90 and the positioning mark 20 overlap. Positioning may also be performed while viewing, as the reference mark 90, the positioning mark 20 of a separator 10 which is already placed in the work area 80.

In this way, when the separator 10 is positioned in place at a predetermined position in the work area 80, the suction hand 30 stops suction, and is separated from the separator 10, and, the processing proceeds to, for example, transportation of a next different separator 10. When necessary, it is also possible for the user to set various settings related to this transportation system via an operation device 70.

The transportation system in FIG. 4 may perform positioning of the separator 10 during, for example, the processing of stacking two separators 10 and an MEA and forming a fuel cell. For example, one separator 10 is positioned in place on the work area 80 using the reference mark 90 as a reference, and the MEA is then placed on the separator 10. Further, using the reference mark 90 as the reference or using the positioning mark 20 of the one separator already placed in the work area 80 as the reference, another separator 10 is placed on the MEA, thereby forming the stacked state in which the two separators tightly hold the MEA.

Further, the transportation system in FIG. 4 may perform positioning of the separator 10 during, for example, a process of stacking a plurality of battery cells and forming a cell stack. For example, a first battery cell is positioned in place in the work area 80 using the reference mark 90 as the reference and using a positioning mark 20 provided on a separator 10 of the first battery cell. Subsequently, a second battery cell is positioned and stacked on the first battery cell using the reference mark 90 or the positioning mark 20 provided on the separator 10 of the first battery cell as the reference and using a positioning mark 20 provided on a separator 10 of the second battery cell. In this way, a cell stack is formed by stacking a predetermined number of the battery cells.

By application of the present embodiment, there is no possibility of, for example, deformation of a through-hole by a penetration pin inserted during positioning performed by fitting the penetration pin in the through-hole, thus increasing the accuracy and reliability of positioning. In addition, because with the present embodiment, there is no possibility of deforming the through-hole, it is also possible to perform positioning more rapidly.

Although a preferred embodiment according to the present invention was described, the above-described example and advantages were provided merely as illustrative examples in every respect, and should not be regarded as imposing limitations on the scope of the present invention. The present invention includes various modifications falling within the spirit of the present invention.

1. A method of manufacturing a fuel cell having a separator, comprising;
optically reading a positioning mark provided on a separator; and
positioning the separator based on the positioning mark, to thereby fix the separator.

2. The method according to claim 1, wherein the separator includes the positioning mark outside a sealed region in which fluid flows.

3. The method according to claim 1, wherein:
the separator is formed in a plate shape having a direction of larger cross-sectional second order moment and a direction of smaller cross-sectional second order moment; and
the separator includes the positioning mark in the center portion along the direction of the smaller cross-sectional second order moment.

4. The method according to claim 1, wherein the separator is formed in the plate shape and has the positioning mark on each of the sides thereof.

5. The method according to claim 1, wherein the positioning mark has a shape by which a position and a direction of the positioning mark can be identified when the separator is moved along a plane.

6. The method according to claim 1, wherein the positioning mark is marked on the separator together with identification information of one of the separator and a battery cell formed by the separator.

7. The method according to claim 1, wherein the positioning mark is provided on the separator during one of a process of providing a manifold hole in the separator and a process of providing a fluid flow path in the separator.

8. The method according to claim 1, wherein the positioning mark is used for positioning the separator during a process of stacking the separator and a membrane electrode assembly to form a battery cell, and for positioning a plurality of battery cells during a process of stacking the plurality of battery cells to form a cell stack.

9. A fuel cell separator comprising a positioning mark used for positioning the separator during assembly of a fuel cell,
wherein the positioning mark is provided on the separator in a fixed manner and is optically read by a sensor during the assembly of the fuel cell.

10. A transportation system of a fuel cell separator, comprising:
a suction hand having a suction surface corresponding to concave and convex portions on a surface of the fuel cell separator; and
a sensor optically reading a positioning mark provided on the fuel cell separator,
wherein the suction hand adsorbing the fuel cell separator controls a position and a direction of the fuel cell separator based on the positioning mark read by the sensor, thereby positioning the separator in place.
